(19) United States
(12) Patent Application Publication
(10) Pub. No.: US 2026/0246281 A1
(43) Pub. Date: Aug. 20, 2026

(54) METHOD AND INSTALLATION FOR PROVIDING ENERGY, PARTICULARLY THERMAL, LOW-CARBON ENERGY, IN AT LEAST ONE BUILDING OR THE LIKE, AND RELATED SYSTEM

(71) Applicant: ACCENTA, Boulogne Billancourt (FR)

(72) Inventors: Pierre TREMOLIERES, Orsay (FR); Philippe BRUAND, Le Vesinet (FR)

(21) Appl. No.: 18/879,925

(22) PCT Filed: Jul. 4, 2023
(86) PCT No.: PCT/EP2023/068457

§ 371 Date: Oct. 24, 2025

(30) Foreign Application Priority Data
Jul. 5, 2022 (FR) 2206811

(51) Int. Cl. H02J 3/46; F24D 11/02; H02J 101/40; H02J 103/30; H02J 105/12

(52) U.S. Cl. CPC H02J 3/46; F24D 11/02; F24D 2200/32; H02J 2101/40; H02J 2103/30; H02J 2105/12

(57) ABSTRACT

Energy collection devices which are linked in an energy-transferring manner to sources including at least one carbon energy source, the at least one carbon energy source including an electricity distribution network;—and energy conversion devices powered at least in part by the collection devices. There is a time-stamped estimate of the carbonization of the production of electricity powering the distribution network, and the installation is operated with the aim of optimization in relation to at least one criterion including a criterion for reducing the carbon footprint of the thermal energy provided by the installation.

The present invention relates to a method for providing low-carbon, particularly thermal, energy in at least one building or the like, with a view to optimization with regard to a number of criteria which may include installation cost, operating costs, reduction in energy consumption, environmental considerations etc.

The present invention also relates to an installation for implementing the method.

The present invention also includes a control system for implementing the method.

### PRIOR ART

The invention is of particular interest, but not limited to, for relatively large building complexes, e.g., apartment blocks, groups of buildings, industrial complexes, hospitals, shopping centers, hotels or hotel complexes, school or university complexes, and so on.

In the building sector, we are familiar with installations for supplying energy from a variety of sources, such as public gas or electricity distribution networks, geothermal probes, thermal solar collectors, photovoltaic solar collectors, aerothermal collectors and so on. Such systems are known to include a variety of devices for converting the energy collected and using it, e.g., heat pumps, Joule-effect heaters, air conditioners, boilers, etc. It is also known to implement a method that regulates the installation by weighting the use of different sources and different devices according to needs and according to economic or other criteria.

Documents FR 2960099 A1, US 2008/092875 A1, WO 2015/014951 A2, EP 3012539 A1, EP 2141419 A1, FR 3065516 A1, EP 1 987298B1, DE 10 2010033909 A1, DE 10022544 A1, US 2018/0283799 A1, KR 20130017182 A and KR 101801775 B1 describe systems of this type, improved in various ways to optimize the use of the most advantageous resources in terms of cost and/or the environment.

WO 2022/029235 A1 teaches to operate the installation according to a scenario covering a period and prescribing for each time slot of the period a combination of activation states of the various devices of the installation. The scenario is established in advance on the basis of various forecasts, including climate, building use and the status of energy storage resources.

There is a growing desire to minimize the “carbon footprint” of human activities, that is, the quantity of carbon emissions, particularly carbon dioxide, that accompanies these activities. Thermal energy supply systems for buildings are concerned, both in terms of structure and operation. The carbon footprint of an installation is a function of the “carbonization” of the energy consumed (number of grams of CO₂ per kWh), as well as the installation's energy requirements.

Some energy production devices, notably solar and aerothermal, operate without releasing carbon. However, because of their investment cost, their footprint, their limited power and/or, above all, the intermittency of their production, they generally have to coexist with other thermal production methods using electricity from a distribution network and/or a carbon-based fuel. A heat pump drawing calories or frigories from a geothermal source is an energy-efficient solution. However, the investment cost and footprint of geothermal collectors for a given average annual output generally preclude their use as the sole complement to non-carbon resources. This leaves the use of heat pumps, possibly reversible, drawing calories or frigories from airborne sources, Joule-effect heating powered by network electricity, and/or combustion heating.

The documents US 2008/0092875 A1 and U.S. Pat. No. 7,958,885 B2 propose to reduce the carbonization of the energy consumed by a thermal energy supply installation by using thermal accumulators.

Minimizing the carbon footprint through trade-offs between different energy sources, one of which is the public electricity network, comes up against a difficulty: the carbonization of electricity provided by the network is highly variable. In countries like France with nuclear and hydroelectric power plants, as well as wind and photovoltaic facilities, the electricity provided by the network is very low-carbon as long as a certain consumption threshold is not exceeded. This threshold depends on climatic and activity factors, as well as on the time of day and the unavailability of certain non-carbon production facilities (nuclear power installation units undergoing maintenance, hydroelectric dams at their minimum level, etc.). Any kWh called up by the network above the aforementioned threshold is probably highly carbon-intensive, as it is supplied by a thermal power plant.

On the other hand, it may make sense to consume carbon-based electricity if it can be used to produce thermal energy very efficiently. For example, it can be advantageous to power a heat pump with carbon or even high-carbon electricity when conditions are right for the heat pump's efficiency coefficient. Moreover, if the need is for cooling, electric power is not always an option. The problem of minimizing the carbon footprint of an energy supply installation in at least one building is therefore a complex one, as it is influenced by the structure of energy supply, the structure of demand, the structure of the installation, the climate and the thermal conditions in the building.

In addition, a growing number of countries are granting advantages in the form of labels, bonuses in calls for tender, financial benefits and/or etc., to installation projects and installations that meet decarbonization targets.

### PURPOSE OF THE INVENTION

The purpose of the invention is thus to propose a method, an installation and a control system for reducing the carbon footprint of the thermal energy consumed in at least one building.

### PRESENTATION OF THE INVENTION

According to the invention, the method for providing thermal energy in at least one building, by means of an installation comprising:
energy collection devices which are linked in an energy-transferring manner to sources comprising at least one carbon energy source, the at least one carbon energy source comprising an electricity distribution network;
energy conversion devices powered at least in part by the collection devices; method wherein, in order to satisfy the installation's requirements in terms of thermal energy, the installation is operated with the aim of optimization in relation to at least one criterion;
is characterized in that a time-stamped estimate of the carbonization of the electrical production supplying the electricity network is provided, and in that the at least one criterion comprises a moderation of the carbon footprint of the thermal energy provided by the installation.

Typically, operation of the installation consists in defining a combination of activation states for the various devices in the system at a given moment, depending on the thermal energy demand from the building and its occupants, and on the energy sources available, such as the distribution network, photovoltaic or thermal solar collectors, geothermal probes, thermal storage structures, boilers, etc.

The invention provides an estimate of the carbonization of electricity available on the electricity distribution network. This carbonization varies greatly over time, depending on the instantaneous energy mix (share of nuclear, hydro, wind, photovoltaic, thermal) used to supply the distribution network.

There are several ways of estimating carbonization. The estimate can be acquired from an external service provider, which may be a distribution network operator or a third-party entity. Alternatively, and in particular if such an estimate is not available, the estimate can be made within the framework of the method, on the basis of data such as meteorological data, calendar data, data relating to the energy mix of the distribution network, etc.

The optimization of the method then takes this estimate into account, with a view to minimizing the installation's carbon footprint over the short and long term, without compromising future performance. This optimization does not necessarily mean that the operation system ensures that the carbon footprint is as low as possible in a given situation. Indeed, moderating the carbon footprint is typically only one of the operation criteria. Other criteria are usually taken into account, such as operating costs, maintenance management of certain devices, management of thermal storage/destockage devices (if any), etc.

Optimization can thus lead to a temporarily more carbon-intensive production, with a very high efficiency for example (this may be the case with thermodynamic production, where the efficiency is not constant and varies according to the conditions under which the machine is operated).

Optimization therefore most often results in a compromise in which the installation's carbon footprint is moderated, but without the installation necessarily operating at its lowest possible carbon footprint at any given time. Moderating the carbon footprint of a thermal installation is therefore a balance sheet result that can be assessed over time.

In some embodiments, data comprising meteorological data and data relating to the production of electricity supplying the distribution network is acquired, and the carbonization estimation takes said data into account. Meteorological data are part of the information used to forecast thermal energy requirements in buildings. If the installation includes photovoltaic and/or solar thermal devices, these data can also be used to forecast the output of these devices. Data relating to the production of electricity supplied to the network are useful for obtaining or refining the carbonization estimate. Although these data do not provide direct information on the carbonization of the electricity provided by the network, they can help to estimate this carbonization. Such useful data may relate to the number of nuclear reactors in operation and/or their total power. They may also relate to hydroelectric power management. They may relate to the power expected from wind generators, etc.

In one embodiment, data comprising a history of the carbonization of electricity having supplied the electricity distribution network over one or more previous time intervals, preferentially over at least one previous year, are acquired, and the estimation takes said data into account. In this embodiment, we assume that at the corresponding date and time in the previous interval (such as the previous year) and in the current interval (such as the current year), carbonization can be compared.

Advantageously, the carbonizations of the electricity supplied to the distribution network in previous years at the corresponding date and time are averaged, and the estimate is obtained on the basis of this average. Previous years can be directly preceding years, or selected years. For example, at least one previous year is selected on the basis of its similarity to the current year, particularly in terms of meteorology and/or carbonization of electricity production supplying the distribution network.

In one embodiment, the at least one previous year is selected according to criteria of similarity to the current year, particularly in terms of meteorology and/or carbonization of electricity production supplying the distribution network.

When a carbonization value based on at least one previous year has been established, according to an improvement the estimate can be obtained by applying a correction that takes into account at least one current parameter, such as meteorological data.

The correction can also take into account certain parameters such as variations in thermal energy demand in the building as a function of calendar events such as working days/weekends/public holidays/school vacations. What is referred to above as “corresponding date and time” does not necessarily mean the same date and time. For example, you can select “matching” dates from previous years, based on the day of the week, the workability of the date (public holiday or working day), or the similarity to the current date in terms of weather. If, for example, July of a previous year was much hotter than August, while August of the current year is very hot, it's best to match the current year's August 15 (public holiday) with the previous year's July 14 (another public holiday).

In another or the same embodiment, the carbonization estimate can also take into account, as a topical parameter, the availability status of the power generation facilities supplying the distribution network. When a significant proportion of decarbonated generation resources, typically nuclear reactors and hydroelectric power installations, are shut down for maintenance, the network operator is likely to have to activate carbon-based resources, such as thermal power plants, to supply the network, particularly in the event of aggravating factors, notably meteorological, such as extreme temperatures.

In one embodiment, the time-stamped estimate is obtained based on the carbonization of electricity provided by the distribution network during at least one year prior to a corresponding date chosen with a calendar offset to be on the same day of the week as the date for which the estimate is produced. In general, the offset date will still be close to the date for which the estimate is produced, so that the climatic data for the two dates are comparable.

In one embodiment, meteorological data are acquired, the carbonizations of electricity production having supplied the network in certain previous years at the corresponding date and time are averaged, and the estimate is obtained by applying to this average a correction taking into account the meteorological data of the year for which the estimate is established, compared with an average of the said previous years.

In an embodiment relating to an installation comprising a combustion heating device, the combustion heating device is activated during a time segment for which the carbonization estimate of the electricity provided by the network is high. Network carbonization is a weighted average of carbonizations from non-carbon (nuclear, hydro), low-carbon (wind, solar) and high-carbon (thermal power plants) generation. A high average means that thermal energy is heavily used. In this case, we can assume that additional kWh will be supplied to the network by thermal power plants. This can be counterproductive in terms of carbon footprint if the extra kWh is used to produce heat at the consumer's premises. It is better to burn the fuel directly at the consumer's premises, both in terms of the overall carbon footprint and in economic terms.

Preferably, the method is applied to an installation comprising at least one thermal storage/destockage unit such as a geothermal unit and/or at least one tank system containing a thermal storage/destockage fluid. Such devices offer very advantageous degrees of freedom for optimization according to the invention.

For example, as part of the optimization method, thermal destocking is carried out when the electricity provided by the electricity distribution network is expected to be high in carbon content, and thermal storage when the electricity provided by the network is expected to be low in carbon content.

According to another example, as part of the optimization, energy provided by the electricity network is consumed in a first time segment where its carbonization is relatively low, thus saving stored energy, and then the storage energy is consumed later when said carbonization is higher than in the first time segment.

In particular, at least some of this energy can be stored to replenish the energy consumed at a later date.

In one embodiment, electrical energy of relatively high carbonization is supplied to a heat pump which is operated between two thermal sources with a small temperature difference between them. In this way, thermal energy can be obtained under advantageous overall conditions. In particular, this energy can be stored for later use, at a time when it would have been less advantageous overall to obtain it. “Globally” refers to the cumulative degree of optimization in obtaining electricity and using it to produce thermal energy.

It is preferred to apply the method to an installation whose collection devices include at least one renewable energy collection device, such as at least one photovoltaic collector, at least one solar thermal collector, at least one aerothermal collector, at least one geothermal collector. Such devices, which supplies totally carbon-free energy on site or in the immediate vicinity, facilitates optimization according to the invention with regard to the criterion of moderating the carbon footprint of the thermal energy provided to the installation.

In a preferred embodiment, at a current installation operation time, the carbonization estimate is a time-stamped forecast extending over a certain period from the current time, and the optimization comprises defining a scenario prescribing a sequence of combinations of devices activation states over said period, the scenario being defined in the sense of an overall optimization over the period with regard to at least one criterion comprising the moderation of the carbon footprint of the thermal energy provided by the installation.

On the basis of forecasts including said time-stamped carbonization forecast, but also forecasts of thermal energy requirements in the installation and of the availability of thermal energy sources other than the network, the scenario dictates for each time, for example for each time segment of, for example, a quarter of an hour, a combination of activation states for the installation's devices. This embodiment of the invention reduces the need for computing power and at the same time manages the thermal trajectory of the entire installation over time. For example, by using the building as a thermal storage/destockage medium, we can allow the building temperature to fall during time segments when energy is expensive and/or carbon-intensive, and anticipate more favorable time segments when it will be advantageous to reheat the building again. Conversely, the scenario can also call for the building to be warmed up in anticipation of later, expected unfavorable time segments, during which consumption can be reduced by letting the building cool down.

If the devices include thermal storage/destockage facilities, the scenario can in the same spirit prescribe thermal discharge when the electricity provided by the network is expected to be carbon-intensive, and thermal storage when the electricity provided by the network is low-carbon.

Preferably, and more generally, optimization with regard to the carbon footprint moderation criterion does not aim for maximum immediate moderation, as this would lead to thermal stocks being systematically emptied except when free carbon-free energy, such as local photovoltaic energy, is in excess, and thus greatly reduce the value of such storage. On the contrary, we're looking for overall moderation over a certain period of time, in particular, in the embodiment with scenario, over the period covered by the scenario, which can typically be 12 months, for example.

In one embodiment, the step of providing a time-stamped forecast of the carbonization of electricity production provided by the distribution network comprises, for each time-stamped time segment, taking into account the carbonization of a time segment preferentially corresponding to at least one previous year, and a correction based on differences between the current year and the at least one previous year. Such corrections may be based on meteorological particularities of the current year compared with the corresponding period of the previous year, on changes in the pool of generating facilities supplying the distribution network, on variations in the use and/or devices of premises, etc.

In one embodiment of the method:
the time-stamped scenario prescribes the energy flows from the various devices during each of the successive time segments in a sense of overall optimization, with regard to at least one criterion including the criterion of moderating the carbon footprint of the thermal energy provided by the installation, over the period covered by the scenario;
the installation is operated by implementing the devices at each moment, taking the scenario into account.

Typically, the scenario as established for the relatively distant future, that is, for the next week, the next month or more, is only one approach to the optimization sought. This approach is more or less appropriate in the light of various past or recently predicted contingencies. Such contingencies may be meteorological, relating to the actual use of the building, relating to the availability of network power generation resources and/or the availability of installation devices, and so on. This is why, preferably, at least at one point in time after the start of the installation operation step, the scenario is updated so that the overall optimization takes into account:
any discrepancies between a history of thermal energy supply in the installation and the scenario before updating; and/or
any discrepancies between recent forecasts and older forecasts on which the scenario is based before updating.

No matter how sophisticated the scenario design, it is hard to avoid a discrepancy between real-life situations and those anticipated by the scenario. If the prescribed scenario is rigidly implemented, the result is certain disadvantages in terms of satisfying demand and optimizing criteria. Preferably, to counteract this the scenario also prescribes methods of adjustment to the actual demand for thermal energy at the current time, and/or to actual parameters of the energy sources at the current time, these methods themselves being optimized with regard to the at least one criterion comprising moderation of the carbon footprint of the thermal energy provided by the installation. For example, if the building's occupants use thermostats to demand more heating than the system would supply according to the scenario, the adjustment procedures prescribe which devices must be activated, or activated differently, to provide this higher-than-expected power demand. In another example, if the electricity available on the network is more expensive or more carbon-intensive than according to the scenario, the balancing arrangements may prescribe, for example, drawing on, or drawing more from, storage. In yet another example, if a heat pump in the system is deficient, the adjustment procedure specifies which other device(s) is to be activated differently to compensate for the deficiency.

In one embodiment of the method, the at least one criterion comprises, in addition to said carbon footprint moderation, an operating cost moderation criterion and/or an energy efficiency criterion. Each criterion is assigned an evaluation scale commensurate with the scales assigned to the other criteria, and the optimization is based on the sum of the evaluations.

For example, scales can be in a monetary unit. The scale of operating costs is then, for example, in real terms. Carbon footprint and energy efficiency are quantified in the same monetary unit, according to a fixed rule of correspondence, for example in euros per kWh and in euros per kg of CO₂.

Advantageously, before establishing the scenario, the following steps are carried out:
establishing an annual schedule of the building's various energy requirements based on a dynamic thermal simulation of the building, its intended use and the annual climatology of the building site;
creating a catalog of energy collection, transformation, utilization and/or storage equipment compatible with the schedule, and with data relating to the building's specifications;
through computer iterations, virtually testing different combinations of devices from the catalog and different sizes of these devices to determine those that are capable of satisfying the schedule at least to a large extent;
establishing the time-stamped scenario of each of the combinations determined to be capable of satisfying the schedule;
selecting one of these determined combinations and the corresponding time-stamped scenario, taking into account the at least one criterion in conjunction with installation considerations; and
building the system corresponding to the selected combination.

In this way, the technique based on the aforementioned scenario makes it possible not only to favorably operate an existing installation, but also, upstream, to give an installation the best possible structure with a view to even better satisfying at least one criterion, in particular the criterion of moderating the carbon footprint.

Considerations relating to the installation include, for example, the amount of investment, the cost of operation and at least one benefit that may derive from meeting energy efficiency and/or carbon footprint moderation standards. Such an advantage may be a favorable label in commercial and/or tax terms.

According to a second aspect of the invention, the installation for providing energy, in particular thermal energy, in at least one building or the like, the installation comprising:
energy collection devices, each linked in an energy-transferring manner to a respective source;
energy conversion devices powered at least in part by the collection devices;
energy-using devices;
a control system capable of defining, for at least some of the devices, different respective activation states selected as a function of parameters, particularly climatic parameters, with a view to optimization in the light of criteria,
   is characterized in that the control system implements a method according to the invention, whether or not supplemented by all or some of its improvements.

In a preferred embodiment, the installation comprises at least one thermal storage/destockage unit, such as a geothermal unit, and/or at least one tank system containing a thermal storage/destockage fluid.

The collection devices can include at least one renewable energy collection device, such as at least one photovoltaic collector, at least one solar thermal collector, at least one aerothermal collector and/or at least one geothermal collector.

According to a third aspect of the invention, the system for regulating an installation intended to supply energy, in particular thermal energy, in at least one building or the like, this installation comprising:
energy collection devices, each linked in an energy-transferring manner to a respective source;
energy conversion devices powered at least in part by the collection devices;
energy-using devices;
   the control system being capable of defining for at least some of the devices different respective activation states chosen as a function of parameters, in particular climatic parameters, in the sense of optimization with regard to criteria, is characterized in that the system is designed to implement in the installation a method according to the invention, whether or not supplemented by all or some of its improvements.

Further features and advantages of the invention will become apparent from the following description of non-limiting embodiments, with reference to the appended drawings.

### BRIEF DESCRIPTION OF THE FIGURES

FIG. 1 is a schematic representation of an installation according to the invention, in a building;

### DESCRIPTION OF THE EMBODIMENTS

The following description is to be understood as describing any feature or combination of features, in the terms used hereinafter or in more general terms, whenever such feature or combination of features produces a technical effect or advantage, even if the feature or combination of features constitutes only part of a sentence or paragraph.

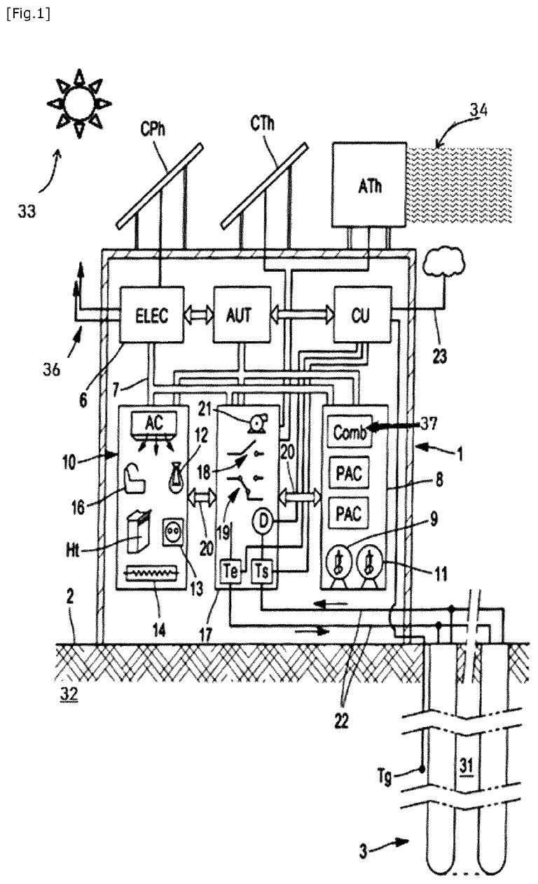

In the example shown in FIG. 1, the installation is associated with a building 1 on a plot of land 2. The installation comprises energy collection devices comprising here: at least one photovoltaic solar collector CPh converting solar radiation 33 into electrical energy; at least one thermal solar collector CTh converting solar radiation 33 into heat absorbed by a heat-transfer liquid flowing through the collector; at least one aerothermal exchanger Ath which can function as a heat collector or heat sink (cold collector) for a heat-transfer liquid flowing through said collector by exchanging calories between the liquid and the outside air 34; several geothermal probes 3; and at least one connection to a public electricity distribution network 36. The geothermal probes 3 are of the BTES type, sunk into an area of the ground 2 and the corresponding subsoil, referred to here as the geothermal medium 31, to distinguish it from the natural soil 32, which is not thermally influenced by the probes 3. There may also be a fuel tank or, as shown, a connection to a fuel distribution network 37, in particular fuel gas. In other embodiments, certain types of collection devices such as CPh, CTh and/or Ath are not present, as the invention can be implemented whenever connection to the network 36 is not the only source of energy capable of supplying the installation with thermal energy (heating and/or cooling) for the building.

An electrical box 6 receives electrical energy from network 36 and photovoltaic collector Cph, and supplies electricity from either source to a power output 7. In some embodiments, the box 6 or a specific box (not shown) can also inject electricity generated by the photovoltaic collector CPh into distribution network 36.

In addition, the installation includes a set 8 of thermal energy conversion and storage devices, namely, in the example, heat pumps PAC, a boiler Comb connected to the fuel source 37 for exceptional periods, as well as a cold tank system 9 and a hot tank system 11 which typically contain additivated water. The set of heat pumps PAC can produce cooling and heating as desired. Cold tank system 9 is designed to store cold by freezing all or part of the water it contains, and to release this cold by total or partial thawing of its frozen contents. Each tank system 9, 11 contains a heat exchanger for exchanging heat with a heat transfer fluid to receive or supply thermal energy in conjunction with the sources, either directly or via an interposed heat pump.

The installation also includes a set 10 of user devices that interfaces with the user (building occupant, technical or management staff) for the building's energy consumption, e.g., lamps 12 and sockets 13, air-conditioning modules AC, heating modules Ht, underfloor heating 14, domestic hot water distribution points 16 (only one of each is shown for simplicity).

The installation also includes a selective connection assembly 17, capable of establishing appropriate connections between the thermal collectors 3, ATh, CTh, the storage and conversion devices 8 and the utilization devices 10. The connection assembly 17 typically comprises pipes, single solenoid valves 18, multi-way solenoid valves 19, and pumps 21. The assembly 17 is connected to the probes 3 by pipes 22 for a heat transfer liquid, generally additive water, circulating in the probes 3 where this heat transfer liquid exchanges heat with the geothermal medium 31.

The installation also features multiple temperature, pressure and flow sensors, as well as current meters, and multiple control devices such as thermostats and switches, some of which are available to users, others to technical or building management staff. For this purpose, we have simply shown a temperature sensor Te for the heat transfer fluid entering the probes 3, a temperature sensor Ts for the heat transfer fluid leaving the probes 3, and a flowmeter D measuring the heat transfer fluid flow rate in the probes 3, as well as optionally a sensor Tg for the temperature of the geothermal medium 31. We know that beyond a certain depth, where it is no longer influenced by surface temperature, the temperature of the geothermal medium 31 increases with depth (geothermal gradient). The sensor Tg is placed at a depth chosen so that the local temperature there is representative of an average for the geothermal medium 31.

The representation of assemblies 8, 10 and 17 as blocks in FIG. 1 is conceptual; in practice, some of the different devices in each of these assemblies may be scattered throughout the building. This is particularly, but not exclusively, the case for utilization devices 10. Moreover, the classification between conversion and storage devices 8 and utilization devices 10 is partly arbitrary. For example, heaters Ht can be Joule-effect energy converters with thermal storage capacity. The double horizontal arrows 20 between these blocks symbolize the fluid links between them.

The system can be configured in a number of ways by a programmable logic controller (PLC) AUT, which issues commands to selectively interconnect the various devices and to control their activation status, depending on parameters including the level of demand for each form of energy (electricity, heating, cooling, domestic hot water, etc.) and the power available from local collectors (CPh, CTh, Ath, 3).

In general, multiple combinations of activation states of different devices are capable of meeting demand. A control unit CU executes an optimization program which issues recommendations to the controller AUT to enable the controller AUT to select and activate the optimum combination of activation states. The recommendations are orders of priority between devices with similar functions, and/or recommendations for devices activation levels, and/or recommendations concerning operating modes for devices with at least two operating modes. Examples of devices with two possible operating modes are devices that can be used to produce cooling or heat (heat pumps PAC if they are reversible), devices that can transfer or acquire energy (tank systems 9, 11), collectors such as probes 3 or the aerothermal collector Ath that can operate as a cooling or heating collector, air-conditioning modules AC that can operate as heating or cooling systems.

The recommendations issued by the control unit CU can be provided in the form of alternative or cumulative possibilities with priority rankings. Preferably, the controller AUT should not be prevented from meeting the demand by excessively restrictive recommendations issued by the control unit CU. In particular, the installation should preferably be fully operational from the point of view of the building's users, even if, for example, a device reaches its power limit or fails.

The controller AUT and control unit CU could be combined into a single “smart” PLC. The subdivision proposed here is advantageous in that it is compatible with a pre-existing installation, equipped with a conventional PLC AUT, which has been retrofitted according to the invention, in particular by adding the control unit CU and possibly some of the collection devices 3, CPh, CTh, ATh, conversion and storage devices 8, utilization devices 10 and connection devices 17. Another advantage of the subdivision proposed here is that all or part of the control unit CU can be installed remotely (as an alternative to what is shown here for illustrative purposes). This means that a single control unit CU can serve several installations. For example, the control unit CU may be owned by a service provider supplying its services to the owner or tenant of building 1. The control unit CU can also be shared by several buildings, such as 1, belonging to the same complex.

The electrical block 6 is connected to the PLC AUT, which operates it. Power output 7 supplies power to the three assemblies 8, 10 and 17, as well as, not shown, the PLC AUT and control unit CU.

The control unit CU has a computer connection port for a link 23, e.g., via the Internet, to one or more data sources, including weather forecasts.

To make its recommendations, the control unit CU takes into account a wide range of data, including economic, meteorological and environmental data, as well as data relating to the correct management of thermal stocks in the geothermal medium 31, in tank systems 9 and 11, and in the building itself, depending on the date, occupancy parameters, etc.

According to the invention, one of the environmental parameters on which the control unit CU bases its recommendations is a time-stamped estimate of the carbonization of the electricity provided by the network. As the overall consumption of network 36 customers varies rapidly over the course of a day, particularly at certain times of the day, the carbonization of electricity can also vary very rapidly, particularly the carbonization of kWh supplied in excess of the production capacity of non-carbon (hydro, nuclear) or low-carbon (wind, photovoltaic) generating facilities. This explains why, according to the invention, it is preferable to have fairly precisely time-stamped data.

For example, as the peak hours of electricity consumption (morning hours in winter in cold or temperate regions, hot summer hours in temperate or hot regions) are well known, the control unit CU can recommend drawing thermal energy from the stocks during such hours and replenishing the stocks outside these hours using network 36, while network 36 supplies low-carbon electricity. In such a case, systems 9, 11 or the building as a thermal reserve are effective.

As another example of a longer-term low-carbon strategy, we know that electricity consumption on network 36 is moderate and more regular during the transition seasons (April-May and September-October in temperate regions). The electricity provided during these periods is low-carbon. During these periods, the control unit CU may recommend consumption of electricity from network 36 to replenish thermal stocks that will be useful during the following season. This means, for example, cooling the geothermal medium 31 and/or cold water system 9 in spring for summer air-conditioning needs, or reheating them in autumn for the cold season.

In tariff zones where the price per kWh supplied by network 36 varies according to the energy situation, the quest for carbonization moderation tends to converge with economic optimization, as periods of high tariffs are often periods of higher carbon production.

When the installation includes production devices such as photovoltaic collectors CPh, solar thermal collectors Cth and aerothermal collectors Aths, using these devices to the maximum of their instantaneous capacity (which depends on instantaneous weather conditions) converges with minimizing the installation's costs and carbon footprint, since the energy they supply to the installation is free and totally non-carbon. If the thermal power that these devices are capable of delivering exceeds the installation's demand, optimization generally involves directing the excess power to thermal storage devices. However, this is not always possible, or may involve trade-offs. For example, in the event of very hot weather, the thermal energy provided by the collectors Ath and/or Cth can be used to heat a swimming pool, the hot water system 11 or a domestic hot water tank (if, for example, they are already at a temperature at least approximately equal to that of the heat transfer fluids that have passed through the collectors Cth and/or Ath), or to cool the cold tank system 9, (if the outside temperature is positive in ° C. while the tank system contents are partially frozen). In such cases, trade-offs may lead to the decision to activate the heat pump, despite the a priori high cost and/or carbon content of electricity.

For example, if a hot spell occurs late in the season, it may be more energy-efficient to store heat with a higher heat pump efficiency coefficient during this hot spell than at much lower temperatures later on. Similarly, if a very cool period occurs late in the cold season, frigories can be advantageously stored during this period for later use in cooling or air-conditioning.

If the difference between the temperature of the heat transfer fluid supplied by the collector Ath or Cth and the hot water system 11 or hot water tank is small, the coefficient of efficiency of a heat pump drawing calories from the collector Ath or Cth to supply them to the tank system 11 or hot water tank will be excellent and will compensate for any poor quality of the electricity consumed by the heat pump in terms of optimization in the sense of the invention.

In another example, the outside temperature is around 5° C., electricity is expensive and/or carbon-intense, while the contents of cold tank system 9 are partially frozen. The heat transfer fluid provided by the aerothermal collector Ath cannot directly supply frigories to tank system 9, as it is warmer than the tank system contents. On the other hand, a heat pump extracting calories from tank system 9 and releasing them into the atmosphere via the aerothermal collector Ath operating as a hot source will be highly efficient, compensating for any poor quality electricity consumed, in terms of optimization within the meaning of the invention.

In such examples, optimization can be not only instantaneous, but also global, that is, including the future. Even if the level of immediate optimization is unsatisfactory, overall optimization can be very satisfactory if the stored thermal energy makes it possible to avoid or restrict subsequent recourse to methods that are far less qualitative in terms of optimization in the sense of the invention.

The search for moderate carbonization is preferably only one criterion among others for optimization according to the invention. In general, the optimization sought is an optimum compromise between operating cost, exogenous energy consumption (that is, other than that produced by the installation's thermal collectors), carbon footprint and thermal stock management, in particular management of the temperature of the geothermal medium, which must not drift in the medium to long term.

Good thermal inventory management is important. If we were to ignore it, it would almost always be more advantageous in the short term to draw on thermal stocks for all the thermal energy required by demand, over and above what is supplied free of charge by the solar collectors Cph and Cth and the aerial collector Ath.

So, more generally, as we have just seen in the non-limiting example above, the optimization is preferably a global optimization encompassing the present moment and a certain period following the present moment. According to the invention, an optimization that is only “imperfect” at the current time is preferably accepted when a better optimization at the current time would likely lead to a worse optimization over the whole period.

In order to obtain said time-stamped carbonization estimate, a first possibility is to obtain this time-stamped estimate via link 23 from network 36 operators and/or electricity producers supplying network 36. However, at present, at least in some countries, notably France, the said producers and operators provide neither values for the carbonization of electricity at the current moment, nor forecasts of future carbonization.

Faced with this situation, the invention provides for the time-stamped forecast to be produced on the basis of information relevant to the carbonization of electricity currently being distributed on network 36 and to be distributed during a future period on network 36.

Such information can relate to the carbonization of electricity provided by network 36 over one or more previous years, day by day or even hour by hour, or preferably quarter-hour by quarter-hour. Such information may come from a public or private source. A private source may be a database that has been built up in previous years specifically for implementing the invention.

Other relevant information relates to the availability of the various power generation facilities supplying the network 36. From one year to the next, some resources may have been temporarily or permanently shut down, while others may have been (re)commissioned. Other relevant information may relate to the general level of demand, which evolves with demographics, with the increasing electrification of energy consumption, but also, in the opposite direction, with energy-saving measures such as the increasing thermal insulation of housing.

In one embodiment, the carbonization of the electricity provided by network 36 is estimated on the basis of a carbonization observed in the past at the corresponding date and time. The carbonization recorded in the past is preferably an average of the carbonizations recorded in several previous years at the corresponding date and time. The date of the current year and the corresponding date of a previous year can be the same calendar date. But different dates on the same day of the week can also be matched, for example two Mondays. Public holidays, school vacation dates, or even days with similar weather conditions can be matched. In general, it will be impossible to achieve a perfect match between a day in the current year and a day in a previous year, or an average of days in previous years. However, in one embodiment, the time-stamped carbonization estimate at the current time is taken to be the carbonization at a corresponding date and time in a previous year, or the average of the corresponding date and time carbonizations in several previous years. In fact, since carbonization is not crucial to the proper operation of the installation, a rough estimate is sufficient in some cases.

In other versions, the time-stamped estimate is refined. Having obtained a first approach to carbonization, for example as described above, we apply a correction to this assessment to obtain the time-stamped carbonization estimate. If the corresponding date is the same calendar date, the correction can take into account differences inherent in the calendar (weekday or weekend, holiday or not, school vacation or not). If the corresponding date is chosen “intelligently”, as mentioned above, the correction takes into account, for example, changes in production supplying network 36, such as the growth of the wind farm, the temporary or definitive closure or (re)commissioning of nuclear power installation units, the variation in electrical power provided by network 36 between the current year and the previous year under consideration, and a weather differential between the current year and said previous year. The corrections to be applied for each parameter of variation can be determined by analyzing the data available for previous years, in terms of calendar, meteorology, power provided by the network, carbonization of electricity, evolution of the generating means, and so on.

In one embodiment, each optimization criterion is assigned an evaluation scale commensurable with the scales assigned to the other criteria, and optimization is performed by searching for an extremum of the sum of the evaluations. For example, scales are pecuniary scales formulated in monetary units such as the euro. In such a case, operating costs are calculated in real terms, a monetary scale is assigned to each kg of CO₂ emitted, whether in the form of carbonization of electricity of network 36 or in the form of local combustion emissions if the installation has at least one combustion unit Comb, and another monetary scale is assigned to each kWh consumed. KWh can be weighted differently for local combustion and for acquisition via network 36, depending on how the non-renewable primary energy cost of each kWh supplied via network 36 is assessed.

The value per kg of CO₂ emitted can be based on the market value of CO₂ (generally formulated in euros per ton), and/or on the tax and image penalties associated with high CO₂ emissions.

Having thus expressed the three parameters relevant to optimization in commensurable terms, we look for the combination of activation states of the various devices in the installation at a given moment that meets demand and for which the sum of the values of the three parameters is optimal, that is, minimal if the scales are in monetary units.

As already mentioned, optimization should preferably take into account the installation's thermal inventory management. In the example shown in FIG. 1, these are the stocks in tank systems 9 and 11 and in the geothermal medium 31. We don't want optimization to systematically lead to thermal destocking.

To achieve this, the first option is to impose a heat content trajectory on each of the storage structures. In the case of hot tank system 11 and geothermal medium 31, the heat content can be measured by temperature. In cold tank system 9, the temperature is generally stable, equal to the temperature at which the liquid and solid phases coexist. Heat content, for example, can be measured by filling level, since the total mass of liquid and solid is constant, while the mass volume of the solid is different from that of the liquid. Under this first option, the actual thermal contents are measured, their deviation from their trajectory is calculated, the deviations are summed up, and this sum is algebraically added to the installation demand to obtain a corrected demand. The combinations of devices states are chosen to return the stocks to their respective trajectories.

According to a second, preferred option, stocks are managed as part of a global optimization that includes not only the present moment but a period following the present moment. In this case, we can accept a certain deficit or even increase in the thermal deficit of the stockpiles in relation to their trajectory, at times when compliance with the trajectory would be unfavorable in terms of the optimization criteria chosen (operating cost, carbonization and exogenous energy consumption in the example taken above) and when we anticipate that making up the deficit will be less penalizing at a later date. In the same or another global optimization method, an excess of thermal stocks can be maintained or increased at times when there is relatively little penalty for time optimization, and when it is anticipated that this excess stock will be of greater benefit in terms of optimization at a later time when, for example, high carbonization and/or a high price for electricity supplying the power network 36 are forecast.

In general, depending on its location (hot, cold, windy, north or south facing, etc.) and its purpose (residential, office, industrial, holiday, etc.), an installation will need most of its heat or cold over the course of a year. Moreover, the geothermal environment is almost always a particularly advantageous heat source for immediate optimization purposes, given the optimization criteria chosen (operating cost, energy expenditure and carbon footprint of the installation). However, if we systematically draw calories and frigories from the geothermal medium, its long-term temperature will drift in the opposite direction to the majority need (that is, will decrease if the majority need is heating). After a few years, the heat becomes increasingly difficult to extract, to the point where the geothermal medium eventually becomes unusable, which is catastrophic for the initial investment. This is why, as explained above, the invention proposes to regulate thermal extraction from the geothermal medium in the sense of respecting a temperature trajectory deemed ideal. This control can be indirect: before starting up the installation, the reactivity (temperature variation) of the geothermal medium is measured when a given amount of heat is extracted. In operation, the temperature is not regulated directly, but according to the thermal extraction performed, which can be translated into the temperature of the geothermal medium according to the initial tests. Such indirect temperature control is more precise than direct measurement using the sensor Tg, as instantaneous temperature variations in the geothermal medium are very slow and therefore very small between two closely spaced times. With this type of indirect control, the sensor Tg is not necessarily present, and if it is, its only purpose is to check from time to time the correspondence rule between drawing and temperature variation, and to correct this rule if a permanent discrepancy seems to be developing between measured temperature and trajectory. In the absence of a sensor Tg, an unfavorable drift of the geothermal environment will nevertheless be observed, as evidenced by the drop in drawing efficiency.

More generally, according to the invention, the optimization sought is a global optimization over a certain period starting at the time of intervention or a little before and extending into the future from the present moment.

To achieve this, forecasts of relevant parameters are used to estimate the building's thermal energy demand at various future points in time, and to select the optimum combination of installation devices states at these points in time to satisfy this demand.

The parameters for which forecasts can be taken into account are typically all or part of the following list: outside temperature, sunshine, wind speed, energy purchase price, energy resale price, environmental parameters including the carbonization of electricity provided by network 36 and also possibly atmospheric pollution parameters, degree of occupancy of the building, status of thermal stocks in storage structures, etc.

Forecasts of climatic parameters and energy tariffs applicable in the coming period are available in a form that can be fed directly to input 23 of the control unit CU. In practice, input 23 is typically a connection to one or more servers via the Internet, and its representation in FIG. 1 is purely illustrative. In the case of carbonization, if forecasts are not available, they can be established using the method described above, either in the control unit CU or remotely, and transmitted to the CU via input 23.

Generally speaking, the method for overall optimization of thermal energy supply in a building preferably corresponds in principle to that described in WO 2022/029235 A1. We will only describe here the adaptation of this known method so that the overall optimization tends to minimize the carbon footprint of the installation's thermal energy supply.

At a current time of operation of the installation, the carbonization estimate of the electricity provided by distribution network 36 is a time-stamped forecast extending over a certain period from the current time. Optimization includes defining a scenario prescribing a sequence of time-stamped combinations of devices activation states over said period. Each state combination is assigned to a time segment defined by its date and time, for example the start time of the time segment. Typically, all time segments have the same duration, e.g., a quarter of an hour, and they follow one another in time. The scenario is defined in terms of overall optimization over the period with regard to at least one criterion, including moderation of the carbon footprint of the thermal energy provided by the installation. Multi-criteria optimization is carried out, for example, as described above. Typically, for each time segment of the period there is a sum of the criteria in the common scale, the scale in monetary units in the example described above. The optimal scenario is the one for which the result of adding the sums obtained for each of the different time segments is the most favorable, that is, the smallest if the scale is expressed in monetary units of cost. The search for the optimal scenario is typically carried out by computer iterations.

In one embodiment, once the time-stamped scenario has been established, the system is operated by implementing the devices at each moment, taking the scenario into account.

Preferably, it is planned to update the scenario during its execution to take into account any discrepancies between a history of thermal energy supply in the installation and the scenario before updating; and/or any discrepancies between recent forecasts and older forecasts on which the scenario before updating is based.

In an improved embodiment, the scenario also prescribes methods of adjustment to the actual demand for thermal energy at the current time and/or to actual parameters of the energy sources at the current time, these methods themselves being optimized with regard to the at least one criterion comprising moderation of the carbon footprint of the thermal energy provided by the installation. In the example shown in FIG. 1, if the controller AUT is confronted with a thermal energy demand different from that forecast by the scenario, it adjusts the scenario in accordance with the adjustment procedures valid for the current time segment.

When constructing or renovating a building or complex, it is a good idea to meet the requirements for labels and/or tax breaks. They also offer a commercial argument by displaying their ecological virtue and promising savings in use.

With this in mind, in addition to the optimization approach described so far, one version of the invention proposes not only to optimize the energy supply of an installation, but also, upstream, to design the installation in such a way as to enable particularly advantageous optimizations with regard to criteria including, in particular, the criterion of moderating the carbon footprint accompanying the satisfaction of thermal energy demand. This can be done as follows:
based on a dynamic thermal simulation of the building, its intended use and the annual climatology of the building site, an annual schedule of the building's various energy requirements is produced;
creating a catalog of energy collection, transformation, utilization and/or storage equipment compatible with the schedule, and with data relating to the building's specifications;
through computer iterations, different combinations of catalog devices and devices sizing are virtually tested to determine those capable of satisfying the schedule at least to a large extent;
the time-stamped scenario is established of each of the combinations determined to be capable of satisfying the schedule;
selecting one of these determined combinations and the corresponding time-stamped scenario, taking into account the at least one criterion in conjunction with installation considerations; and
building the system corresponding to the selected combination.

The “dynamic thermal simulation”, or DTS, mentioned above is a study carried out prior to the construction of a building, providing a schedule of the building's thermal energy requirements as a function of multiple factors such as site location, exposure, sunshine, whether the site is windy or not, construction materials used and thermal insulation measures to be implemented, and the building's purpose (residential, office, hotel, etc.). Depending on the country, this or an equivalent study may be designated by a different local terminology.

Considerations relating to the installation include the amount of investment, the cost of operation and at least one benefit that may derive from meeting energy efficiency and/or carbon footprint moderation standards.

Of course, the invention is not limited to the examples described and represented. The installation shown in FIG. 1 is just one of an infinite number of possible examples, and is also only a very schematic vision of a real installation that would involve much more than one device of each kind, much more than one geothermal probe, for example up to more than 100 probes, and would often concern more than a single building, etc.

The invention can be applied to a wide variety of building complexes. In some cases, heat (for housing, offices, etc.) and cold (for cold storage, for example) are required simultaneously. In other cases, we only need hot (cold countries), or almost only cold (hot countries). The invention is compatible with all these special cases.

1. A method for providing thermal energy in at least one building, by means of an installation comprising:
energy collection devices which are linked in an energy-transfer manner to sources comprising at least one carbon energy source, the at least one carbon energy source comprising an electricity distribution network;
energy conversion devices powered at least in part by the collection devices;
wherein, in order to satisfy the installation's requirements in terms of thermal energy, the installation is operated with the aim of optimization in relation to at least one criterion; and
a time-stamped estimate of the carbonization of the electrical production supplying the electricity network is provided, and the at least one criterion comprises reducing the carbon footprint of the thermal energy provided by the installation.

2. The method according to claim 1, characterized in that data are acquired comprising meteorological data and data relating to the production of electricity supplying the electricity distribution network and in that the carbonization estimate takes said data into account.

3. The method according to claim 1, characterized in that data are acquired comprising a history of the carbonization of electricity having supplied the distribution network during one or more previous time intervals, preferentially during at least one previous year, and in that the carbonization estimate takes said data into account.

4. The method according to claim 3, characterized in that the carbonizations of the production of electricity having supplied the network in certain previous years at the corresponding date and time are averaged, and the estimate is obtained on the basis of this average.

5. The method according to claim 4, characterized in that the at least one previous year is selected according to criteria of similarity, in particular meteorological and/or carbonization of the electricity production supplying the distribution network, with the current year.

6. The method according to claim 1, characterized in that the estimate is obtained by applying to a carbonization value based on at least one previous year a correction taking into account at least one current parameter.

7. The method according to claim 1, characterized in that meteorological data are acquired and the carbonization estimate takes account of said meteorological data as a current parameter.

8. The method according to claim 1, characterized in that the carbonization estimate takes into account as a current parameter an availability state of the electricity generation means supplying the distribution network.

9. The method according to claim 1, characterized in that the carbonization estimate takes into account as a current parameter the day of the week and/or the workability of the day to which the estimate relates.

10. The method according to claim 1, characterized in that the time-stamped estimate is obtained on the basis of the carbonization of electricity provided by the distribution network during at least one year prior to a corresponding date chosen with a calendar offset in order to be on the same day of the week as the date for which the estimate is produced.

11. The method according to claim 1, the installation comprising combustion heating devices characterized in that the combustion heating devices are activated during a time segment for which the carbonization estimate of the electricity provided by the network is high.

12. The method according to claim 1, characterized in that it is applied to an installation comprising at least one thermal storage/destockage device such as a geothermal device and/or at least one tank system containing a thermal storage/destockage fluid.

13. The method according to claim 1, characterized in that thermal destocking is carried out when the electricity provided by the network is expected to have a high carbon content, and thermal storage is carried out when the electricity provided by the network is expected to have a low carbon content.

14. The method according to claim 1, characterized in that, as part of the optimization, energy provided by the electricity distribution network is consumed in a first time segment when its carbonization is relatively low, thus saving storage energy, and the storage energy is subsequently consumed when said carbonization is higher than in the first time segment.

15. The method according claim 1, characterized in that electrical energy having a relatively high carbonization is supplied to a heat pump which is operated between two thermal sources having a small temperature difference between them.

16. The method according to claim 1, characterized in that it is applied to an installation whose collection devices comprise at least one renewable energy collection device such as at least one photovoltaic collector, at least one solar thermal collector, at least one aerothermal collector, at least one geothermal collector.

17. The method according to claim 1, characterized in that at a current time of operation of the installation, the carbonization estimate is a time-stamped forecast extending over a certain period from the current time, and in that the optimization comprises defining a scenario prescribing a sequence of combinations of activation states of devices over the said period, the scenario being defined in the sense of an overall optimization over the period with regard to the at least one criterion comprising the moderation of the carbon footprint of the thermal energy provided by the installation.

18. The method according to claim 17, characterized in that the step of providing a time-stamped forecast of the carbonization of the electricity production provided by the distribution network comprises, for each time-stamped time segment, taking into account the carbonization of a time segment preferentially corresponding to at least one previous year, and if appropriate a correction based on differences between the current year and the at least one previous year.

19. The method according to claim 17, characterized in that:
the time-stamped scenario prescribes the energy flows of the different devices during each of the successive time segments in a sense of overall optimization, with regard to at least one criterion comprising the criterion of moderating the carbon footprint of the thermal energy provided by the installation, over the period covered by the scenario; and
the installation is operated by implementing the devices at each moment, taking the scenario into account.

20. The method according to claim 19, characterized in that, at least at one point in time after the start of the step of operating the installation, the scenario is updated so that the overall optimization takes account of:
any discrepancies between a history of thermal energy supply in the installation and the scenario before updating; and/or
any discrepancies between recent forecasts and older forecasts on which the scenario is based before updating.

21. The method according to claim 19, characterized in that the scenario further prescribes methods of adjustment to the actual demand for thermal energy at the current time and/or to actual parameters of the energy sources at the current time, these methods themselves being optimized with regard to the at least one criterion comprising the moderation of the carbon footprint of the thermal energy provided by the installation.

22. The method according to claim 17, characterized in that before establishing the scenario, the following steps are carried out:
establishing an annual schedule of the building's various energy requirements based on a dynamic thermal simulation of the building, its intended use and the annual climatology of the building site;
creating a catalog of energy collection, transformation, utilization and/or storage equipment compatible with the schedule, and with data relating to the building's specifications;
through computer iterations, virtually testing different combinations of devices from the catalog and different sizes of these devices to determine those that are capable of satisfying the schedule at least to a large extent;
establishing the time-stamped scenario of each of the combinations determined to be capable of satisfying the schedule;
selecting one of these determined combinations and the corresponding time-stamped scenario, taking into account the at least one criterion in conjunction with installation considerations; and
building the system corresponding to the selected combination.

23. The method according to claim 22, characterized in that the considerations relating to the installation comprise the amount of investment, the operating cost and at least one benefit that may derive from meeting energy efficiency and/or carbon footprint moderation standards.

24. The method according to claim 23, characterized in that the at least one criterion comprises, in addition to the said moderation of the carbon footprint, a criterion of moderation of the operating cost and/or a criterion of energy efficiency, in that each criterion is assigned an evaluation scale commensurable with the scales assigned to the other criteria, and the optimization is carried out according to the sum of the evaluations.

25. An installation for providing energy, in particular thermal energy, in at least one building or the like, the installation comprising:
energy collection devices, each linked in an energy-transferring manner to a respective source;
energy conversion devices powered at least in part by the collection devices;
energy-using devices; and
a control system capable of defining, for at least some of the devices, different respective activation states selected as a function of parameters, particularly climatic parameters, with a view to optimization in the light of criteria,
the control system implements a method according to claim 1.

26. The installation according to claim 25, characterized in that it comprises at least one thermal storage/destockage device such as a geothermal device and/or at least one tank system containing a thermal storage/destockage fluid.

27. The installation according to claim 25, characterized in that the collection devices comprise at least one renewable energy collection device such as at least one photovoltaic collector, at least one solar thermal collector, at least one aerothermal collector, at least one geothermal collector.

28. A system for controlling an installation for providing energy, in particular thermal energy, in at least one building or the like, said installation comprising:
energy collection devices, each linked in an energy-transferring manner to a respective source;
energy conversion devices powered at least in part by the collection devices; and
energy-using devices;
the control system being capable of defining for at least some of the devices different respective activation states chosen as a function of parameters, in particular climatic parameters, in the sense of optimization with regard to criteria, the system is designed to implement in the installation a method according to claim 1.
